(19) United States
(12) Patent Application Publication
(10) Pub. No.: US 2007/0025381 A1
(43) Pub. Date: Feb. 1, 2007

(54) Method and apparatus for allocating processing in a network

(76) Inventors: Jay Feng, San Jose, CA (US); Michael Hong Dang, Los Gatos, CA (US); John Fenwick, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/192,861

(22) Filed: Jul. 29, 2005

(51) Int. Cl. H04L 12/28

(52) U.S. Cl. 370/431

(57) ABSTRACT

In a method and apparatus for allocating processing in a network, a processing request is received. It is determined if a first processing node in the network is capable of handling the processing request. If the first processing node is incapable of handling the processing request alone, one or more additional processing nodes from the network are allocated to assist in handling the processing request.

### TECHNICAL FIELD

Embodiments of the present invention relate to methods and apparatus for allocating processing amongst various processors in a network of computers.

### BACKGROUND

In the computing and Internet world, networks are used for sharing information from place to place. Networked systems can be centrally controlled, but are often implemented without a centralized control server, as can be the case in a peer-to-peer network. Networked systems can also be purely distributed systems or can have a centralized catalog that documents data held by each node in the system; the essence however is that networks are for moving and sharing data.

For example, FIG. 1 shows an exemplary peer-to-peer data sharing network 100. In FIG. 1, peer nodes (110, 120, 130, 140, 150, and 160) are represented by circles. Each peer node, 110 for example, is linked with other peer nodes (120 and 160 for example), and arrows in FIG. 1 show these nodal interconnections. In a peer-to-peer data-sharing network such as network 100, if one data providing peer node, such as peer node 110, is bogged down or unable to provide the requested data, then a request for data is forwarded to another peer node, such as peer node 120, that can more capably supply the data. With peer-to-peer systems, data can be delivered from place to place, to clients, users, or consumers in a reliable non-centralized way. However, in a peer-to-peer network or any other type of network, computing power, processing power, and intelligence of the network are not currently delivered, shared, or redirected in this manner.

This is not to say that processing is never shared. One method of sharing processing duties in a network is parallel processing in a network. In parallel processing, a pre-written program specifies how processing will be split among multiple processors. Usually, this means assigning equal work to all processors in a networked system, or else pre-assigning certain tasks to certain processors. This works well with pre-defined processing requests, but does not lend itself to adapting on the fly to various requests for processing power that are not within the pre-programmed directions.

As an example, a user can access a network for certain processing services such as an Internet search. When queried with this processing request, the network will normally direct the request to a processor in the network that provides this service. In this scenario, there are two options, either the processing system in the network provides the search service or it fails to provide the search service. There are various reasons for failure ranging from system overload to a simple inability to answer the question that is asked of the processor. If this processor is bogged down, or unable to provide an answer, the user will simply wait a long time for the search service that was requested, or else find out that it cannot be provided.

### DISCLOSURE OF THE INVENTION

A method and apparatus for allocating processing in a network are described. A processing request is received. It is determined if a first processing node in the network is capable of handling the processing request. If the first processing node is incapable of handling the processing request alone, one or more additional processing nodes from the network are allocated to assist in handling the processing request.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is an example peer-to-peer network structure according to prior art.

FIG. 2 is a block diagram of an exemplary computer system with which embodiments of the present invention may be implemented.

FIG. 3 is a block diagram of an apparatus for allocating processing in a network according to one embodiment of the present invention.

FIG. 4 is an exemplary graph of instructions processed at a processing node according to one embodiment of the present invention.

FIG. 5 is a flowchart of a method for allocating processing in a network according to one embodiment of the present invention.

FIG. 6 is flowchart of a method for allocating processing in a network according to one embodiment of the present invention.

FIG. 7 is a flowchart of a method for allocating processing in a network according to one embodiment of the present invention.

### DETAILED DESCRIPTION OF THE INVENTION

In the following detailed description of the present invention, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

### Notation and Nomenclature

Some portions of the detailed descriptions, which follow, are presented in terms of procedures, steps, logic blocks, flowcharting blocks, processing, and other symbolic representations of operations on data bits that can be performed on computer memory. These descriptions and representations are the means used by those skilled in the distributed processing art to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system.

Unless specifically stated otherwise as apparent from the following discussions, it is appreciated that throughout the present invention, discussions utilizing terms such as “receiving,” “utilizing,” “allocating,” “determining,” “continuing,” “distributing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Computer System

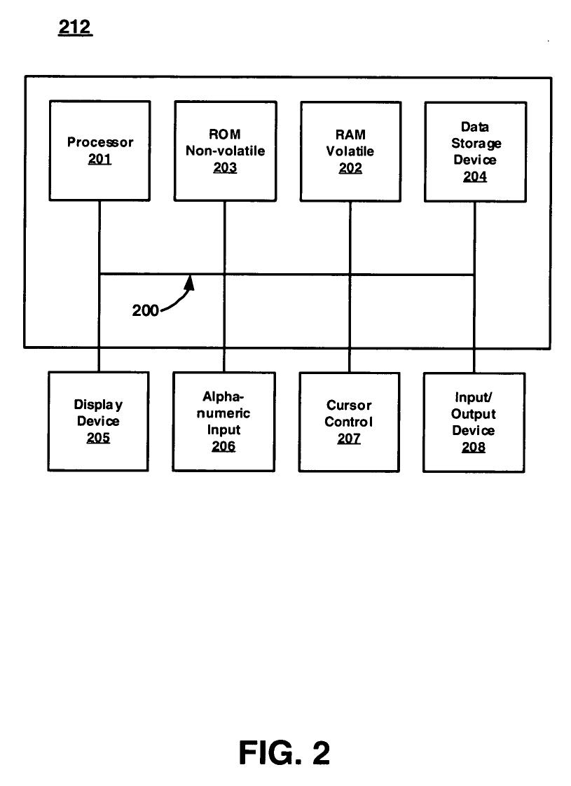

Referring first to FIG. 2, a block diagram of an exemplary computer system 212 is shown. It is appreciated that computer system 212 described herein illustrates an exemplary configuration of an operational platform upon which embodiments of the present invention can be implemented. Nevertheless, other computer systems with differing configurations can also be used in place of computer system 212 within the scope of the present invention. That is, computer system 212 can include elements other than those described in conjunction with FIG. 2.

Computer system 212 includes an address/data bus 200 for communicating information, a central processor 201 coupled with bus 200 for processing information and instructions; a volatile memory unit 202 (e.g., random access memory [RAM], static RAM, dynamic RAM, etc.) coupled with bus 200 for storing information and instructions for central processor 201; and a non-volatile memory unit 203 (e.g., read only memory [ROM], programmable ROM, flash memory, etc.) coupled with bus 200 for storing static information and instructions for processor 201. Computer system 212 may also contain an optional display device 205 (e.g. a monitor or projector) coupled with bus 200 for displaying information to the computer user. Moreover, computer system 212 also includes a data storage device 204 (e.g., disk drive) for storing information and instructions.

Also included in computer system 212 is an optional alphanumeric input device 206. Device 206 can communicate information and command selections to central processor 201. Computer system 212 also includes an optional cursor control or directing device 207 coupled with bus 200 for communicating user input information and command selections to central processor 201. Computer system 212 also includes signal communication interface (input/output device) 208, which is also coupled with bus 200, and can be a serial port. Communication interface 208 may also include wireless communication mechanisms. Using communication interface 208, computer system 212 can be communicatively coupled with other computer systems over a communication network such as the Internet or an intranet (e.g., a local area network).

### Appratus for Allocating Processing in a Network

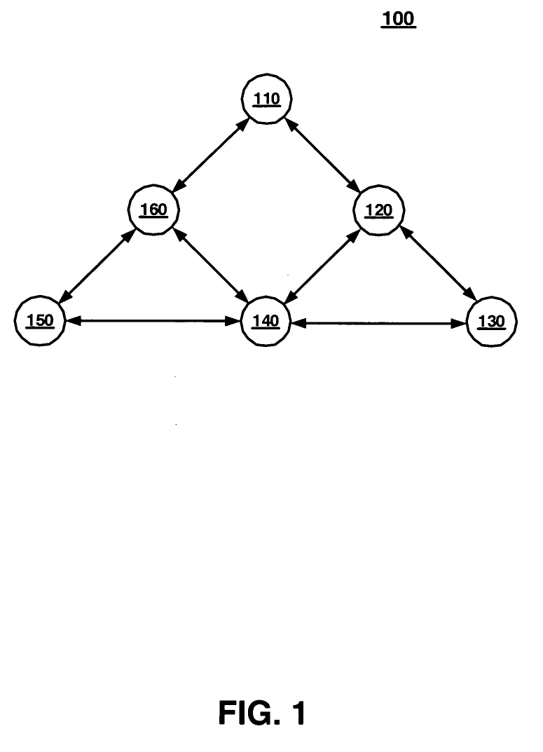

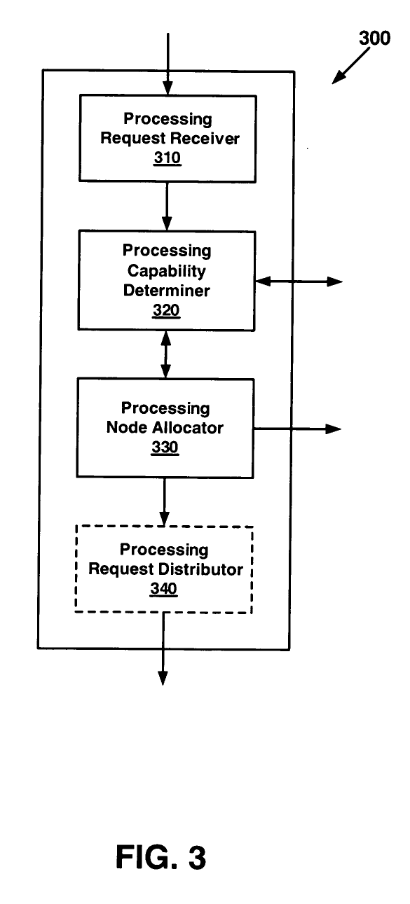

With reference now to FIG. 3, a block diagram is shown of an apparatus 300 for allocating processing in a network in accordance with one embodiment of the present invention. The following discussion will begin with a description of the structure of the present invention. This discussion will then be followed with a description of the operation of the present invention. With respect to the structure of the present invention, processing allocator apparatus 300 of the present embodiment allocates processing amongst processing nodes in a network of processing nodes. Processing allocator 300 can be used in peer-to-peer networks such as the network arrangement exemplified in network 100 of FIG. 1, in centrally controlled networks such as client server networks, and in other networks as known in the art. Processing allocator 300 can be resident on one or more processing nodes in a network, a central control node in a network, several nodes in a network, one or more data processing nodes in a network, or every node in a network. Other configurations within the scope of the present invention are possible.

### Structure of the Present Apparatus for Allocating Processing in a Network

The processing allocator apparatus 300 contains an optional processing request receiver 310, a processing capability determiner 320, a processing node allocator 330, and an optional processing request distributor 340.

Processing request receiver 310 is for receiving processing requests from a user, an outside source, another network, or from within a network. In one embodiment of the present invention, optional processing request receiver 310 is coupled with a communications line and receives processing requests for processing allocator apparatus 300 over this communications line.

In one embodiment of the present invention, optional processing request receiver 310 is coupled with processing capability determiner 320. Processing capability determiner 320 receives processing requests as an input from processing request receiver 310. Processing capability determiner 320 then determines the capabilities of a processing node or nodes in a network that the processing request may be sent to. The capability determination is based upon weighing the capabilities of a processing node or nodes (based on metadata of the node(s)), in light of requirements of the processing request. In an embodiment of the present invention where optional processing request receiver 310 is not used, the functions of processing request receiver 310 are included within processing capability determiner 320.

Processing capability determiner 320 is coupled with processing node allocator 330. Processing node allocator 330 is for allocating processing nodes in a network to perform processing on a processing request. Processing node allocator 330 communicates with processing capability determiner 320 to determine which processing nodes in a network are capable or incapable of handling a processing request. This communication allows processing node allocator 330 to make allocations based on the results of weighted rules applied to metadata of the processing nodes, and in some embodiments based on other factors such as sensitivity of the data, or computational costs, speed, reliability or other measurable factors associated with a particular node. Processing node allocator 330 then sends the processing request on to the allocated processing node or nodes, or optionally on to processing request distributor 340.

In one embodiment of the present invention, processing node determiner 330 is coupled with optional processing request distributor 340. Processing request distributor 340 is for distributing tasks from a processing request to the processing node or nodes that have been allocated to perform the processing. This can include sending an entire processing request to a single allocated processing node, or subdividing a processing and sending parts of the request to one or more allocated processing nodes. The movement of a processing request can also take place in various ways, such as copying the binary executables to a new node from an old node, downloading applets to a new node, transferring all or part of the data being processed to a new node, transferring the processing request to a node where data is stored, or a combination of these ways and/or other ways. In an embodiment that does not include optional processing request distributor 340, some or all of the functionality of processing request distributor 340 is included in processing node allocator 330.

### Operation of the Present Apparatus for Allocating Processing in a Network

Processing allocator apparatus 300 allocates processing requests and processing nodes in a network. The network can be a peer-to-peer network structure such as the example network 100 of FIG. 1, a client server network, a peer-to-peer network with a central directory, or another kind of network. The networked processing nodes can comprise locally networked processing nodes such as over an intranet, disruptively networked processing nodes such as over the Internet, or some combination of the two. Processing nodes can be computer processors, independent computer systems, sub-networks, data delivery processors, combinations of these, or other processing nodes as known in the art. The example peer-to-peer network structure 100 of FIG. 1 is extensively utilized to explain how the present invention can be applied to an existing network. However, it should be appreciated that the description merely focuses on network 100 for clarity and simplicity sake, and that the embodiments of the present invention can readily be applied to other types of peer-to-peer and non-peer-to-peer networks.

Processing allocator apparatus 300 is resident on at least one node in a network and in some embodiments is resident on more nodes. For instance, in one embodiment of a peer-to-peer network structure, such as network 100 of FIG. 1, processing allocator apparatus 300 resides within every processing node in the network. This configuration of network 100 has several benefits. It allows for the processing nodes in network 100 to dynamically reconfigure based on changing conditions to improve processing efficiency and overall reliability of network 100.

By allowing distributed subsystems in a network to make decisions, processing pressures on a single central server in a tradition centralized server solution are alleviated. It also enables distributed network configuration, thereby enabling flexible and dynamic global network topologies, bandwidth, and connections. It enables distributed service configuration by means of software, hardware, and network configuration, thereby enabling flexible and dynamic services under different network, content, and system cooperating conditions. It enables distributed monitoring ands support configuration by means of software, hardware, and network configurations thereby enabling flexible and dynamic monitoring and support under different system operating conditions. It also maximizes the overall reliability of the entire network system, maximizes the overall network throughput, maximizes the functionalities provided to users of the contents in the subsystems, and maximizes the flexibility of the monitoring, support, and reconfiguration of the network.

In the embodiment of the present invention shown in FIG. 3, processing allocator apparatus 300 comprises optional processing request receiver 310. Processing request receiver 310 has an input that is coupled with a communications line for receiving processing requests. These can be processing requests from a user, from within the network, from another node in the network, or from any device that can send information to processing request receiver 310 over the communications line. Processing request receiver 310 is coupled with processing capability determiner 320 and passes the received processing requests along to processing capability determiner 320.

Processing capability determiner 320 receives the processing requests and then determines if a processing node in the network is capable of processing the request. Processing capability determiner 320 utilizes a set of weighted rules to determine if a particular processing node is capable of handling a processing request. Processing capability determiner 320 determines what sort of software application, data, services, or components, or processing power a processing node needs in order to perform the processing request. It checks network metadata to see which nodes in the network have access to the required software applications, components, data, services, or other required items. In one embodiment of the present invention, this information is retrieved from a central directory server. In one embodiment of the present invention, each processing node constantly maintains this information about other nodes in the network. In yet another embodiment of the present invention, processing capability determiner 320 polls processing nodes in the network to get this information as needed.

In one embodiment of the present invention, processing capability determiner 320 checks other measurable factors associated with processing nodes, such as the ability to process sensitive data, or the cost, speed, or reliability associated with a particular processing node. This entails automatically searching out and discovering computational processes, data services, other services, components, applications available in a network, and capabilities of nodes in the network. The requested information can be compiled in the form of a list or menu of information related to the processing request. In one embodiment, this list of information about available services, components, applications, and processes on the network is used to automatically or manually create a bundled end product of the services, processes, applications, and components. Automatic creation can be done based on predefined rules, or based on items required by or associated with a particular basic service in a request. Searching out and automatically bundling items associated with a basic service allows creation of a full service from a combination of capabilities available on a network. The system of weighted rules is applied to all information collected about available services, processes, applications, components, and the like, thus allowing the optimization of the means of producing a bundled end product.

In one embodiment of the present invention, processing capability determiner 320 also checks network metadata on factors such as the throughput capability of the nodes that have access to the required applications, data or components. The point of checking is to see which nodes can most quickly process the processing request. Polling or monitoring bandwidth capability into and out of a processing node is one method of assessing part of throughput capability. Another part of throughput capability (or processing capacity) can be assessed by polling or monitoring the amount of instructions being processed at any particular processing node, and comparing that amount to the maximum capability of the processing node.

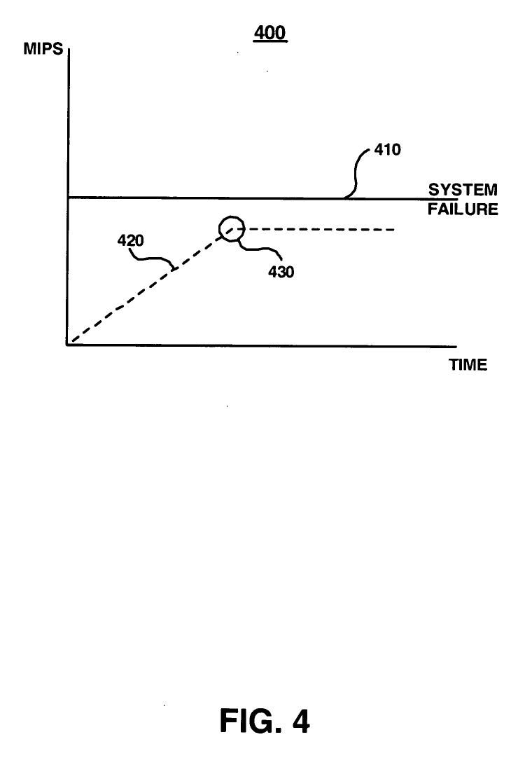

As an example, FIG. 4 shows an exemplary graph 400 of instructions processed at a processing node according to one embodiment of the present invention. Graph 400 is a visual display of an exemplary way to track throughput capability of a processor. The X-axis of graph 400 displays passing time, while the Y-axis of graph 400 shows millions of instructions per second (MIPS) executed by the processing node that is being measured. The system failure line 430 shows a threshold of MIPS that indicate the maximum number of instructions that a processor is capable of processing without failure. Dashed line 410 shows the changing processing load on the processor over time. Area 430 indicates a plateau where the amount of instructions being processed has leveled off somewhere below system failure 410. By monitoring the MIPS levels of processors in a system, processing capability determiner 320 can avoid assigning a processing task that will overburden a processor and can also actively reassign tasks from processors that are overburdened, before failure level 410 is reached. This is in effect a way to load balance processing performed in a system to increase the overall throughput. Monitoring MIPS levels in processing nodes also gives a warning period before a failure or overcapacity system causes a system shutdown. This allows time for a processing allocator apparatus 300 on one node (or on several nodes) in a network to notify other nodes in the network, gather data, and reconfigure processing to another node before a processing node goes down. A similar capability exists by monitoring bandwidth fluctuations into and out of processing nodes.

The weighted rules used by processing capability determiner 320 give weight to whether a processing node has access to the applications needed to process a task, whether a processing node is already close to being overburdened with its current processing tasks, and also historical data on how a processor has performed on similar tasks in the past. Historical data can be things like how long a processing node has taken to perform similar tasks, how accurate a processing node has been at similar processing tasks in the past, or information about bandwidth bottle necks into and out of a processing node based on a time of day. These are merely examples of historical data that can be used, other data points and historical data can be figured into the weighted rules. Many forms of historical data require that logs or ratings on past performance be kept; some forms of historical data can also depend on user feedback to indicate satisfaction with results.

In some embodiments of the present invention, weight can also be given to other factors such the ability of a node to process sensitive data, or computational costs, speed, reliability, measurable factors associated with a particular node, or other services, processes or components associated with a node. Weighted rules have default settings to deal with many conditions that are initially set by a user or programmer of processor allocation apparatus 300. The weighted rules can then remain static, or can be allowed to self modify over time through the incorporation of feedback about accuracy of determinations that are made. Evolving weighted rules over time with historical data can develop expert rules that improve allocations made by processor allocation apparatus 300.

Each input to processing capability determiner 320 is assigned a weight. When all the inputs for a network of processing nodes are combined, each processing node is given a score by processing capability determiner 320. The scores estimate how well each processing node will perform a processing request. If no processing node in the network is capable of processing request, an appropriate message is forwarded on to processing node allocator 330 and then onward back to requesting entity. Otherwise, processing capability determiner 320 passes the scores for the various processing nodes onward as an input to processing node allocator 330.

Processing node allocator 330 assigns the processing request to the processing node with the best score or scores based on the results of the weighted rules as applied to network metadata by processing capability determiner 320. Processing node allocator 330 then continually interacts with processing capability determiner 320 to ensure that no processing nodes are so heavily tasked that they approach their failure point in terms of MIPS or else become unable to function due to bandwidth bottlenecks. Additional processing nodes are continually allocated until a sufficient processing capability is allocated to perform the processing request, or else all processing nodes available in the network have been exhausted. This means that if a particular processing node is becoming bogged down or fast approaching system failure 410 in terms of MIPS or bandwidth, then processing node allocator 330 searches for another node or nodes capable of taking on or sharing the processing burden. At least three possibilities exist for averting a potential system failure 410 in a processing node.

In the first case, processing node allocator 330 identifies another node or nodes, based on the scores from processing capability determiner 320, to completely take over the processing task for the first node. The processing task is then completely shifted over to the replacement node for processing. In the second case case, processing node allocator 330 identifies one or more processing nodes, based on the scores from processing capability determiner 320, to share the processing burden with the first processor. In this case, processing node allocator 330 forwards this information on as an input to the optional processing request distributor 340. In the third case, if no additional node or nodes exist with the proper applications to perform a processing request, processing node allocator 330 allocates the processing request to a processing node with sufficient bandwidth and processing capacity in MIPS. Once this node (or nodes) is allocated as a replacement a storage server from within the network provides the newly allocated processing node(s) with all the mirrored system intelligence in the form of programs, processing states, parameters, and contents to continue processing the request. The newly allocated processing node then reconfigures itself based on the data passed by the storage server and processes the processing request.

Thus, in an instance where no additional node or nodes exist with the proper applications to perform a processing request, an available node is populated with the data and the intelligence to perform the necessary processing task. As an example, in one embodiment, no additional node or nodes exist with the medical imaging applications necessary to perform processing on a particular medical image. In such an embodiment, the proper medical imaging application and various other intelligence, for example, processing states. parameters, and the like, in addition to the medical image itself, are sent to the newly allocated node.

Processing request distributor 340 receives a list of allocated processing nodes from processing node allocator 330 and then subdivides the processing request between the allocated nodes. In situations where efficiency can be gained at least a portion, and perhaps all, of the processing request is distributed among the one or more additional processing nodes allocated by processing node allocator 330.

The processing request can be subdivided and distributed in a variety of ways. This includes sending an entire processing request to a single allocated processing node, or subdividing a processing and sending parts of the request to one or more allocated processing nodes. The movement of a processing request can also take place in various ways, such as copying the binary executables to a new node from an old node, downloading applets to a new node, transferring all or part of the data being processed to a new node, transferring the processing request to a node where data is stored, or a combination of these ways and/or other ways. For instance in one embodiment of the present invention, processing request distributor 340 attempts to evenly split processing of the processing request among the allocated processing nodes. In another embodiment of the present invention, processing request distributor 340 splits the processing request based on the capability scores of the allocated processing nodes. For instance, in one embodiment of the present invention, more processing is assigned to a node that has more available throughput capacity. In another embodiment of the present invention, more processing is assigned to a processing node that has historically performed similar tasks better or more quickly. In another embodiment, processing is assigned to a node where data required in the processing is also stored, which can be especially useful in situations where the data involved is too sensitive, or too voluminous to move to another node or nodes.

After a processing request has been allocated to a processing node, or distributed among a group of processing nodes, the processing of the processing request is continually monitored. If an allocated processing node fails or becomes unacceptably slow (based on default, user-defined, or historical parameters), then processing node allocator 330 and processing request distributor 340 search for other processing nodes to allocate the processing request to or distribute part of the processing load to. This monitoring, allocating, and distributing continues until sufficient processing power is allocated to perform the processing request, all nodes in the network are exhausted, or else the processing task is finished.

### Methods for Allocating Processing in a Network

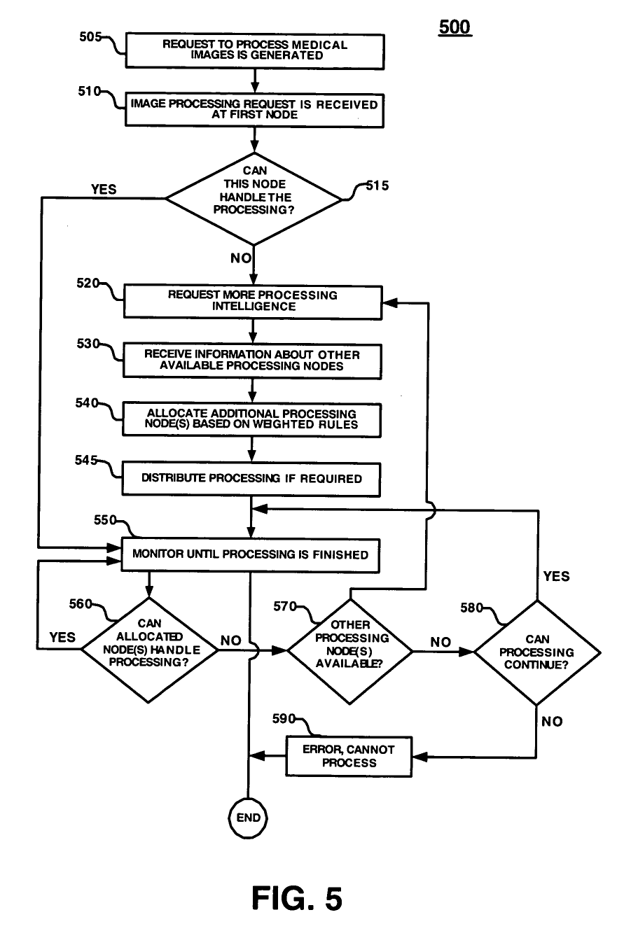

FIG. 5 is a flowchart 500 of a method for allocating processing in a network according to one embodiment of the present invention. An example situation is provided for discussing flowchart 500 and setting forth in detail the operation of an embodiment of the present invention. Throughout the operational description, an exemplary peer-to-peer network structure 100, as shown in FIG. 1, comprised of processing nodes, such as exemplary computer system 212 shown in FIG. 2, will be used. The network and processing nodes in the exemplary network are for processing medical images such as X-Rays, computerized axial tomography (CAT) scans, and magnetic resonance images (MRIs). The peer-to-peer network structure 100, exemplary computer system 212, and medical images examples are used for convenience in describing the present invention. It should be appreciated that the description merely focuses on application of the embodiments of the present invention to network 100 for clarity and simplicity sake, and that the embodiments of the present invention can readily be applied to other types of peer-to-peer and non-peer-to-peer networks. It should also be apparent to those skilled in the arts of network control and processing allocation that embodiments of the present invention are well suited for use with numerous other applications, data types (such as audio, video, or picture files), network structures, and processing node structures.

In one embodiment of the present invention, processing allocator apparatus 300 is resident within a computer such as computer system 212 and is used to allocate processing in a peer-to-peer network structured like exemplary network 100. Each node (110-160) in network 100 represents a computer system 212 containing processing allocator apparatus 300. Each of the peer processing nodes (110-160) is connected to other such peer processing nodes in peer-to-peer network 100. In the presently described embodiment of the invention, network 100 is a network of computers used to process medical images.

In 505 of flowchart 500 a request to process medical images is initiated. For purposes of this discussion, this is a request for processing of an X-Ray and an MRI of a broken arm. A radiographer at an emergency medical center has just taken a digital X-Ray and an MRI of a patient's broken arm and needs to have them both processed quickly for analysis. Quick results are a priority, but high resolution is not a priority as the images will only be used to roughly estimate the location and severity of the damage. She sends the X-Ray and MRI to computer system 212 of processing node 110 for analysis.

In 510 of flowchart 500, the image processing request is received at a first processing node. Computer system 212 of processing node 110 receives this request to process an arm X-Ray and an arm MRI in the processing request receiver 310 of the processing allocator apparatus 300 that is resident within computer system 212.

In 515 of flowchart 500, processing allocator apparatus 300 determines node 110 is capable of handling the processing request. This determination step is equivalent to the function of the processing capability determiner 320 of processing allocator apparatus 300. Processing capability determiner 320 notes that the processing request is for an X-Ray and an MRI of an arm. Processing capability determiner 320 then analyzes the capabilities of processing node 110 and finds that processing node 110 has no spare processing power, and further, only possesses the applications to analyze chest X-Rays. If processing node 110 had been capable of performing the image processing request, 550 of flowchart 500 would have been entered and the images would have been processed and the progress of the processing monitored. This is equivalent to processing node allocator 330 allocating node 110 to process the X-Ray and MRI, and then monitoring the progress in conjunction with processing capability determiner 320 to assign processing help if the processing becomes stalled or aborted.

However, since node 110 is incapable of processing the X-Ray and MRI, 520 of flowchart 500 is entered, and more processing intelligence is requested. In one embodiment of the present invention, this is done by polling other nodes in peer-to-peer network 100 to see which processing nodes have the desired capabilities such as applications, bandwidth, and processing throughput capacity. In other embodiments of the present invention, this information is obtained from a central directory node in the network. In still other embodiments of the present invention, each processing node in network 100 maintains its own private continually updated directory of what other nodes are capable of doing. In yet another embodiment of the present invention, the applications needed to process the arm X-Ray and arm MRI are transferred to node 110. In another embodiment, some or all of the processing is moved to where the data is located, which can be useful when dealing with sensitive data, large data files, or long transmission distances between network nodes. However, for purposes of this example, node 110 broadcasts a request to its peer processing nodes (120-160) for help in processing an X-Ray and an MRI of an arm.

In 530 of flowchart 500, requested information about capabilities of other available processors is received. This is equivalent to processing capability determiner 320 requesting and receiving this information. The requested information can be compiled in the form of a list or menu of information related to the processing request. In one embodiment, this list of information about available services, components, applications, and processes on the network is used to automatically or manually create a bundled end product of the services, processes, applications, and components. For example, items from a list can be chosen to process the X-Ray and MRI, print labels, print a list of doctors available for follow up treatment, and send a bill to the patient. Data and processes are then moved as needed between nodes or to other nodes to facilitate creation and delivery of the bundled product. In one embodiment, some additional services such as billing are automatically bundled with a basic service request to create a full service.

In the current example, the results of the request for processing intelligence show that: processing node 120 only processes CAT scans; processing node 130 processes arm X-Rays with medium resolution and has sufficient excess processing capacity; processing node 140 processes arm MRIs with high resolution but has no excess processing capacity; processing node 150 processes arm X-Rays with high resolution but is nearly overloaded processing another task; and processing node 160 processes full body MRIs using an older application that has a lower resolution when applied to a specific body part such as an arm, and also has a large surplus of processing capacity.

In 540 of flowchart 500, additional processing node(s) are allocated based on weighted rules. Weighted rules are defaults preset by a programmer or by an application user, or rules that are evolved over time with historical data. In the currently described embodiment of the present invention, the user presets five weighted rules. In other embodiments of the present invention additional or different weighted rules can be preset, and rules can be modified over time with historical data.

The first weighted rule in this example embodiment of the present invention is called “Arm X-Ray?” and it checks for the ability to process an Arm X-Ray. A maximum weight is given for being able to process an arm X-Ray, while a minimum weight is given for not being able to process an arm X-Ray. The second weighted rule is called “Arm X-Ray resolution.” Since this user simply wants a quick look at where the arm is broken, any resolution (low or high) gets a maximum weight. The third weighted rule in this example embodiment of the present invention is called “Arm MRI?,” and it checks for the ability to process an arm MRI. A maximum weight is given for being able to process an arm MRI, while a minimum weight is given for not being able to process an arm MRI. The fourth weighted rule is called “Arm MRI Resolution.” Since this user simply wants a quick look to initially assess damage where the arm is broken, any resolution (low or high) gets a maximum weight. The fifth weighted rule in this example embodiment of the present invention is called “Time for result.” The user wants the result quickly, so a processing node with the spare processing capacity to process this request quickly gets heavy weighting, while a processing node with low spare capacity gets low weighting.

Table 1 shows an example of applying these weightings to the results received in 530 of flowchart 500. A scale of 0-10 is used for each category, with a 10 receiving the most weight. Processing nodes 130 and 160 have tied for the highest weighted score, and each is capable of processing part of the request. As previously explained, many other factors can be used to calculate a weighted score, and a weighting system may have more or less factors than are shown in the example of Table 1. Additionally, a plurality of such weightings can be done for various applications, services, or components that will be utilized to create a bundled response to a processing request.

TABLE 1
Exemplary Weighted Rule Results for a Medical Imaging
Processing Request

| | Weight | | | | | |
|---|---|---|---|---|---|---|
| | HI | LOW | HI | LOW | HI | |
| | Arm | Arm X-Ray | Arm | Arm MRI | Time to | |
| Node | X-Ray? | Resolution | MRI? | Resolution | Result | Total |
| 110 | 0 | 0 | 0 | 0 | 0 | 0 |
| 120 | 0 | 0 | 0 | 0 | 0 | 0 |
| 130 | 10 | 10 | 0 | 0 | 10 | 30 |
| 140 | 0 | 0 | 10 | 10 | 2 | 22 |
| 150 | 10 | 10 | 0 | 0 | 2 | 22 |
| 160 | 0 | 0 | 10 | 10 | 10 | 30 |

In 540 of flowchart 500 additional processing node(s) are allocated. The weighted results from 530 are passed on to 540 of flowchart 500 and used to allocate a processing node or nodes. From Table 1, it is evident that the highest scoring processing nodes are processing node 130 which can process an arm X-Ray quickly, and processing node 160 which can process an arm MRI quickly. Processing nodes 130 and 160 are both allocated to process the medical images. Processing node allocator 330 does the allocation. If only one node is being allocated, the node is notified, and the processing begins and is monitored as shown in 550. If more than one node is allocated, then the processing task needs to be distributed.

In 545 of flowchart 500, processing is distributed if required. Allocation information and scoring information are passed from 540 to 545 of flowchart 500. At this point, the initial image processing request is analyzed again, and the processing tasks are split between allocated processing nodes in a way that will allow for efficient processing. In this example embodiment of the present invention, optional processing request distributor 340 performs the distribution. As previously explained, there are several methods for distributing processing. For instance, processing can be moved in whole, processing can be moved in parts, processing and data can both be moved to an independent node that did not previously have the data or the processing capabilities, processing can be moved to the data, data can be moved to the processing, or a combination of such movements can take place. In the presently described embodiment of the invention processing request distributor 340 performs the distribution based on processing node expertise. The result is that processing of the arm X-Ray is distributed to processing node 130, while processing of the arm MRI is distributed to processing node 160.

In 550 of flowchart 500, processing is monitored until finished. At this stage, progress of the processing is monitored by processing capability determiner 320 in conjunction with processing node allocator 330, to ensure that processing does not stall or abort without some remedial corrective action being attempted by processing allocation apparatus 300. When processing of the images finishes, monitoring ceases and the end of the flowchart is reached. If a problem is sensed, such as a processing node slowdown or failure, the process moves on to 560 of flowchart 500.

In 560 of flowchart 500, a decision is made as to whether the allocated node(s) can handle the assigned processing. This decision process is the same as previously described in conjunction with 515. Processing capability determiner 320 analyzes information from the allocated processing nodes (130 and 160) to determine if they are still capable of carrying out the assigned processing. If they are capable, monitoring in 550 resumes. If one or both are incapable of performing the processing request, the process moves to 570 to check to see if other nodes are available to share the processing burden.

Assuming for the present example that processing 130 has gone off line and is no longer capable of processing the arm X-Ray, 570 of flowchart 500 will check for other available nodes. Processing capability determiner 320 communicates with processing node allocator 330 to carry out the functions of 570. In this example, 570 checks to see if other unallocated nodes are available to be allocated for processing an arm X-Ray. If so, the flowchart move to 520 and more processing intelligence is requested. Following the same process as previously described in 520, 530, 540, and 545, processing node 150 will be selected to process the arm X-Ray since it had the next highest weighted score and is capable of processing arm X-Rays. If no unallocated nodes are available, meaning all nodes in network 100 have been exhausted, the process moves on to 580.

In 580 of flowchart 500, a decision is made as to where processing can continue. Processing capability determiner 320 determines if processing can continue with the currently allocated processing nodes. In the current example, if processing node 130 is down, but processing node 160 is still up, part of the processing can continue, but part will be halted. The X-Ray cannot currently be processed by network 100, so an error message indicating that the network cannot process the processing request is generated as shown in 590, and this part of the processing then ceases. Meanwhile, processing node 160 is still processing the arm MRI and monitoring will continue as previously described in 550.

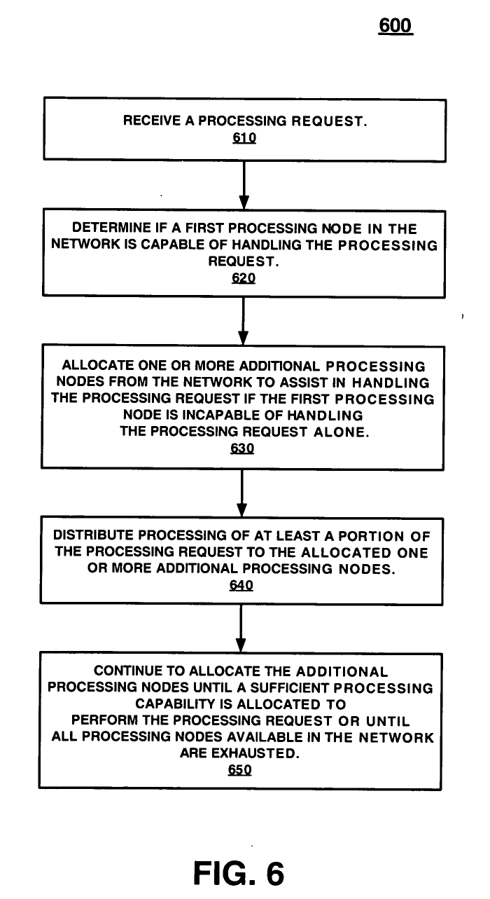

FIG. 6 is a flowchart 600 of a method for allocating processing in a network according to one embodiment of the present invention. The network can be a client-server network, a peer-to-peer distributed network, a peer-to-peer network with a central directory, or another form of network structure as known in the art.

In 610 of FIG. 6, in one embodiment of the present invention, a processing request is received. Receiving of a processing request is described in conjunction with processing request receiver 310 of FIG. 3 and 510 of flowchart 500. Likewise, in 610 this comprises receiving a processing request as an input via a communications line.

In 620 of FIG. 6, in one embodiment of the present invention, a determination is made as to whether a first processing node in a network is capable of handling a processing request. This determination is described in conjunction with processing capability determiner 320 of FIG. 3 and also in conjunction with 515, 520, and 530 of flowchart 500. In one embodiment of the present invention, after a processing request is received within a network, the processing required is compared to the capabilities of a processing node to if the first processing node will exceed a MIPS (Million Instructions Per Second) failure threshold by handling the processing request. In one embodiment of the present invention, after a processing request is received with in a network, the processing required is compared to the capabilities of a processing node to determine if the first processing node has access to software applications required to perform said processing request. Other embodiments can make other determinations about processing capabilities and throughput of this first processing node.

In 630 of FIG. 6, in one embodiment of the present invention, one or more additional processing nodes from the network are allocated to assist in handling the processing request if the first node is incapable of handling the processing request alone. This allocating is described in conjunction with processing node allocator 330 of FIG. 3 and also in conjunction with 530, 540, and 545 of flowchart 500. Additional processing nodes are allocated based on a results of weighted rules applied to metadata of the one or more additional processing nodes that are analyzed for allocation. In one embodiment of the present invention, this metadata is received from on or more processing nodes within a peer-to-peer network. In one embodiment of the present invention, this metadata is received from a directory server in the network. In one embodiment of the present invention, metadata can comprise software application capabilities, or capacity indicators such as MIPS cycles available or bandwidth available at a particular processing node.

In 640 of FIG. 6, in one embodiment of the present invention, at least a portion of processing of the processing request is distributed to the one or more additional processing nodes that are allocated. This distributing is described in conjunction with processing request distributor 340 and also in conjunction with 540 and 545 of flowchart 500. In one embodiment of the present invention, this distributing comprises giving the entire processing request to an allocated processing node or dividing the processing among a plurality of processing nodes.

In 650 of FIG. 6, in one embodiment of the present invention, additional processing nodes are continually allocated until a sufficient processing capability is allocated or else all processing nodes available in the network are exhausted. This continual allocation is described in conjunction with processing node allocator 330 of FIG. 3 and also in conjunction with 550, 560, 570, and 520 of flowchart 500. Evaluating for continual allocation of additional processing nodes ensures that enough processing capacity is allocated when processing at an allocated processing node becomes stalled or aborted.

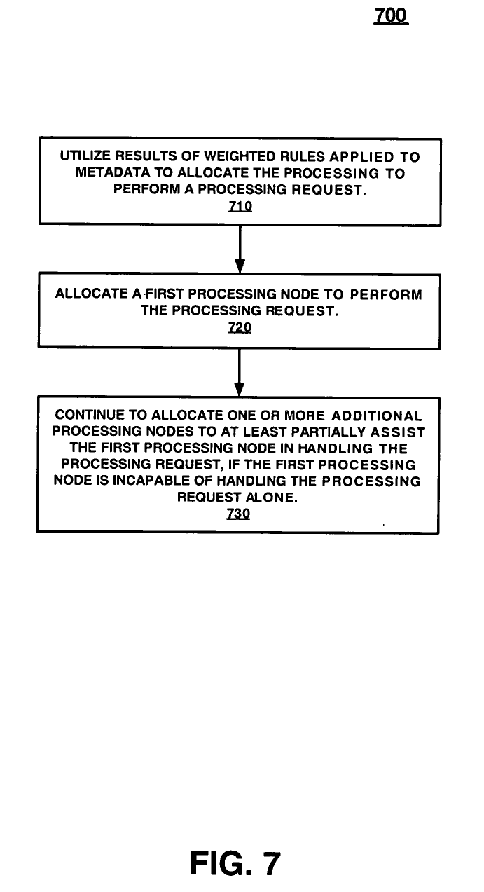

FIG. 7 is a flowchart 700 of a method for allocating processing in a network according to one embodiment of the present invention.

In 710 of FIG. 7, in one embodiment of the present invention, the results of weighted rules applied to metadata are utilized to allocate processing to perform a processing request. This utilization is described in conjunction with processing capability determiner 320, which applies the weighted rules to metadata about processing nodes in a network. It is also in conjunction with processing node allocator 330, which allocates processing nodes based on the results of the weighted rules applied to metadata. This utilization of a weighted set of rules is further described in conjunction with 515, 520, 530, 540 and 545 of flowchart 500. In one embodiment of the present invention, this metadata comprises application capabilities of processing nodes in a network. In one embodiment of the present invention, this metadata information comprises throughput capacity indicators of processing nodes in a network, such as available MIPS or available bandwidth. In one embodiment of the present invention, metadata is retrieved from one or more processing nodes in the network. In one embodiment of the present invention, metadata is retrieved from a central directory server in the network.

In 720 of FIG. 7, in one embodiment of the present invention, a first processing node is allocated to perform the processing request. This allocation of a first processing node is described in conjunction with processing capability determiner 320 and processing node allocator 330 of FIG. 3 and also in conjunction with 510 and 515 of flowchart 500.

In 730 of FIG. 7, in one embodiment of the present invention, continual allocation of one or more additional processing nodes to assist the first processing node in handling the processing request if the first processing node is incapable of handling the processing request alone is shown. Continual allocation of one or more additional processing nodes is described in conjunction with processing node allocator 330 and processing request distributor 340 of FIG. 3 and 530, 540, 545, 550, 560, 570, 580, 590, and 520 of flowchart 500. In one embodiment of the present invention, continual allocation of one or more additional processing nodes ceases when sufficient processing capability is allocated to perform the processing request or else all available processing nodes in the network are exhausted.

Although specific steps are disclosed in flowcharts 600 and 700, such steps are exemplary. That is, embodiments of the present invention are well suited to performing various other (additional) steps or variations of the steps recited in flowcharts 600 and 700. It is appreciated that the steps in flowcharts 600 and 700 may be performed in an order different than presented, and that not all of the steps in flowcharts 600 and 700 may be performed. In one embodiment of the present invention, flowchart 600 is implemented as computer-readable program code stored in a memory unit of computer system 212 and executed by processor 201 (FIG. 2). In one embodiment of the present invention, flowchart 700 is implemented as computer-readable program code stored in a memory unit of computer system 212 and executed by processor 201 (FIG. 2).

What is claimed is:

1. A method of allocating processing in a network, said method comprising:
receiving a processing request;
determining if a first processing node in said network is capable of handling said processing request; and
allocating one or more additional processing nodes from said network to assist in handling said processing request if said first processing node is incapable of handling said processing request alone.

2. The method as recited in claim 1 wherein said method of allocating processing in a network further comprises distributing processing of at least a portion of said processing request to said allocated one or more additional processing nodes.

3. The method as recited in claim 1 wherein said method of allocating processing in a network further comprises continuing to allocate said additional processing nodes until a sufficient processing capability is allocated to perform said processing request or else all processing nodes available in said network are exhausted.

4. The method as recited in claim 1 wherein said allocating one or more additional processing nodes further comprises:
populating said one or more additional nodes with intelligence required to perform said processing request.

5. The method as recited in claim 1 wherein said determining if said first processing node in said network is capable of handling said processing request comprises determining if said first processing node has access to software applications required to perform said processing request.

6. The method as recited in claim 1 wherein said allocating one or more additional processing nodes from said network to assist in handling said processing request if said first processing node is incapable of handling said processing request alone comprises allocating said one or more additional processing nodes based on results of weighted rules applied to metadata of said one or more additional processing nodes, said metadata comprising software application capabilities and throughput capacity indicators of said available processing nodes.

7. The method as recited in claim 6 wherein said allocating said one or more additional processing nodes based on results of weighted rules applied to metadata of said one or more additional processing nodes comprises receiving said metadata from one or more processing nodes within a peer-to-peer network.

8. The method as recited in claim 6 wherein said allocating said one or more additional processing nodes based on results of weighted rules applied to metadata of available processing nodes comprises receiving said requested metadata from a directory server in said network.

9. A computer useable medium having computer-readable program code stored thereon for causing a computer system to execute a method of allocating processing in a network, said method comprising:
utilizing results of weighted rules applied to metadata to allocate said processing to perform a processing request;
allocating a first processing node to perform said processing request; and
continuing to allocate one or more additional processing nodes to at least partially assist said first processing node in handling said processing request, if said first processing node is incapable of handling said processing request alone.

10. The computer-useable medium of claim 9 wherein said continuing to allocate one or more additional processing nodes to at least partially assist said first processing node in handling said processing request comprises computer-readable code for causing said computer system to cease allocation of said one or more additional processing nodes when sufficient processing capability is allocated to perform said processing request or else all available processing nodes in said network are exhausted.

11. The computer-useable medium of claim 9 wherein said utilizing results of weighted rules applied to metadata to allocate said processing to perform a processing request comprises computer-readable code for causing said computer system to retrieve metadata about each processing node from a central directory computer in said network.

12. The computer-useable medium of claim 9 wherein said utilizing results of weighted rules applied to metadata to allocate said processing to perform a processing request comprises computer-readable code for causing said computer system to retrieve metadata about said processing nodes from one or more said processing nodes in said network.

13. The computer-useable medium of claim 9 wherein said utilizing results of weighted rules applied to metadata to allocate said processing to perform a processing request comprises computer-readable code for causing said computer system to retrieve metadata about throughput capacity indicators of said processing nodes.

14. The computer-useable medium of claim 9 wherein said utilizing results of weighted rules applied to metadata to allocate said processing to perform a processing request comprises computer-readable code for causing said computer system to retrieve metadata about software application capabilities of said processing nodes.

15. The computer-useable medium of claim 9 wherein said utilizing results of weighted rules applied to metadata to allocate said processing to perform a processing request comprises computer-readable code for causing said computer system to populate said one or more additional nodes with intelligence required to perform said processing request.

16. An apparatus for allocating processing in a network, said apparatus comprising:
a processing request receiver for receiving a processing request;
a processing capability determiner for determining if a first processing node in said network is capable of handling said processing request; and
a processing node allocator for allocating one or more additional processing nodes from said network to assist in handling said processing request if said first processing node is incapable of handling said processing request alone.

17. The apparatus as recited in claim 16 wherein said apparatus for allocating processing in said network comprises a processing request distributor for distributing at least a portion of said processing request from said first processing node to said allocated one or more additional processing nodes.

18. The apparatus as recited in claim 16 wherein said processing capability determiner for determining if said first processing node in said network is capable of handling said processing request further comprises determining if said first processing node has access to software applications required to perform said processing request.

19. The apparatus as recited in claim 16 wherein said processing node allocator for allocating said one or more additional processing nodes further comprises continuing to allocate said additional processing nodes until a sufficient processing capability is allocated to perform said processing request or else all said processing nodes available in said network are exhausted.

20. A method of allocating processing in a network, said method comprising:
receiving a processing request;
determining if a first processing node in said network is available to handling said processing request; and
allocating one or more additional processing nodes from said network to assist in handling said processing request if said first processing node is incapable of handling said processing request alone, wherein said allocating further comprises populating said one or more additional nodes with intelligence required to perform said processing request.

21. The method as recited in claim 20 wherein said method of allocating processing in a network further comprises distributing processing of at least a portion of said processing request to said allocated one or more additional processing nodes.

22. The method as recited in claim 20 wherein said method of allocating processing in a network further comprises continuing to allocate said additional processing nodes and populating said one or more additional nodes with intelligence required to perform said processing request until a sufficient processing capability is allocated to perform said processing request or else all processing nodes available in said network are exhausted.

23. The method as recited in claim 20 wherein said determining if said first processing node in said network is capable of handling said processing request comprises determining if said first processing node has access to software applications required to perform said processing request.

24. The method as recited in claim 20 wherein said allocating one or more additional processing nodes from said network to assist in handling said processing request if said first processing node is incapable of handling said processing request alone comprises allocating said one or more additional processing nodes and populating said one or more additional nodes with intelligence required to perform said processing request based on results of weighted rules applied to metadata of said one or more additional processing nodes, said metadata comprising software application capabilities and throughput capacity indicators of said available processing nodes.

25. The method as recited in claim 20 wherein said allocating said one or more additional processing nodes based on results of weighted rules applied to metadata of said one or more additional processing nodes comprises receiving said metadata from one or more processing nodes within a peer-to-peer network.

26. The method as recited in claim 24 wherein said allocating said one or more additional processing nodes based on results of weighted rules applied to metadata of available processing nodes comprises receiving said requested metadata from a directory server in said network.
